(19) United States
(12) Patent Application Publication
(10) Pub. No.: US 2015/0072082 A1
(43) Pub. Date: Mar. 12, 2015

(54) Method of Maintaining A Painted Surface

(71) Applicants: Derek Zahajko, Maple Valley, WA (US); Michael Zahajko, Maple Valley, WA (US)

(72) Inventors: Derek Zahajko, Maple Valley, WA (US); Michael Zahajko, Maple Valley, WA (US)

(21) Appl. No.: 14/481,002

(22) Filed: Sep. 9, 2014

Related U.S. Application Data
(60) Provisional application No. 61/876,268, filed on Sep. 11, 2013.

(51) Int. Cl. B05D 1/28; B05C 17/00

(52) U.S. Cl. CPC B05D 1/28; B05C 17/00
USPC 427/429

(57) ABSTRACT

A method of maintaining a painted surface by storing a volume of matched touch up paint in a squeezable container having a built in dispenser and applicator installed on the container and rubbing a porous pad into which a dispensed volume of touch up paint has been received onto a blemished area of the painted surface.

### CROSS REFERENCE TO RELATED APPLICATIONS

This application claims the benefit of U.S. provisional application No. 61/876,268, filed on Sep. 11, 2013.

### FIELD OF THE INVENTION

The present invention relates to a method of maintaining a painted surface by touching up blemishes on the painted surface.

### BACKGROUND OF THE INVENTION

Conventional approaches to applying paint typically involve the use of a paint brush or paint roller, and a container for storing the paint. This approach can be efficient for large painting projects where there is an expectation that all of the paint will be used. However, touch-up and finishing projects typically require only a small amount of paint, and are usually done sometime after the original paint job was completed.

In these instances, a user will typically need to find the original paint container and use a paint brush to make the necessary touch-ups after which the container must be resealed and stored, and the brush cleaned. This is a particular inconvenience.

This approach also often results in spilled paint as the user moves the paint container to each location requiring touch-up. In many cases, more paint is spilled or lost or remaining in a temporary paint container such as a paint tray than is actually needed for the touch-up project, so that waste of paint results.

It is an object of the present invention to provide a method for maintaining a painted surface which minimizes waste of touch up paint and the time and trouble required for carrying out touch up of the painted surface.

### SUMMARY OF THE INVENTION

The above recited object and others which will be apparent to those skilled in the art is achieved by a method including permanently storing matching touch up paint in a special storage container which is compact, the container combined with dispenser and with applicator to enable the paint to be directly applied to the surface from the container.

The compact container is of small volume, i.e., preferably 8 ounces or less, and is configured to be easily squeezable by the hand of a user, so as to create pressure in the container sufficient to controllably force a small volume of paint into a dispenser-applicator installed on the top of the container.

The applicator comprises a sponge or other porous pad connected to a dispensing pressure sensitive plunger that is selectively moved by compressing the pad against a surface to allow paint to be squeezed from the container and into the applicator.

The pad is cleaned after each use.

When the device is not in use, a cap is used to enclose and seal off, dispenser and applicator to protect against spills, inadvertent marks and prevent premature drying of the paint.

### BRIEF DESCRIPTION OF DRAWINGS

FIG. 1 is a pictorial view of a device used to carry out the method of the invention.

FIG. 2 is an enlarged fragmentary exploded pictorial view of the combined paint storage and applicator device shown in FIG. 1.

FIG. 3 is an enlarged top view of an assembled applicator pad and dispenser plunger included in the device shown in FIG. 1.

FIG. 4 is an enlarged bottom view of the plunger shown in FIG. 3.

FIG. 5 is an enlarged partially sectional view of the dispenser plunger and porous pad with a pad holder piece therefore.

FIG. 6 is an enlarged sectional view of the components shown in FIG. 5, showing the resiliently deflectable elements of the dispenser plunger being further compressed by compression of the porous applicator pad against a surface.

FIGS. 7A and 7B are fragmentary pictorial views of alternative types of applicator components.

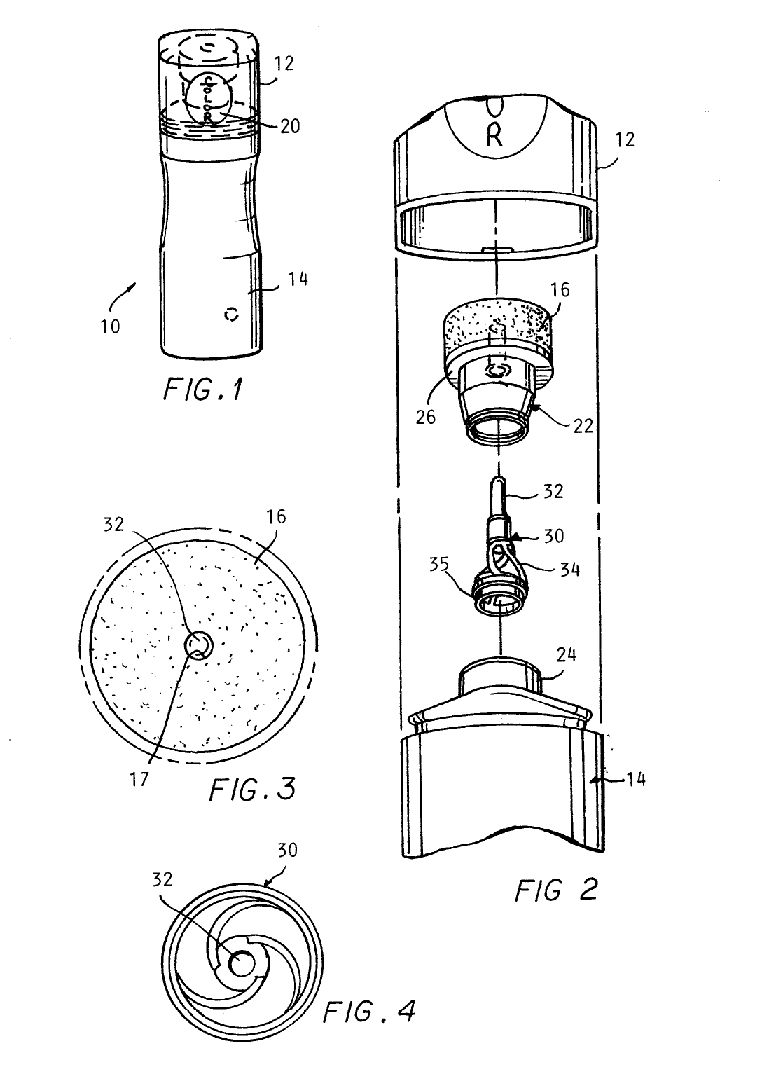

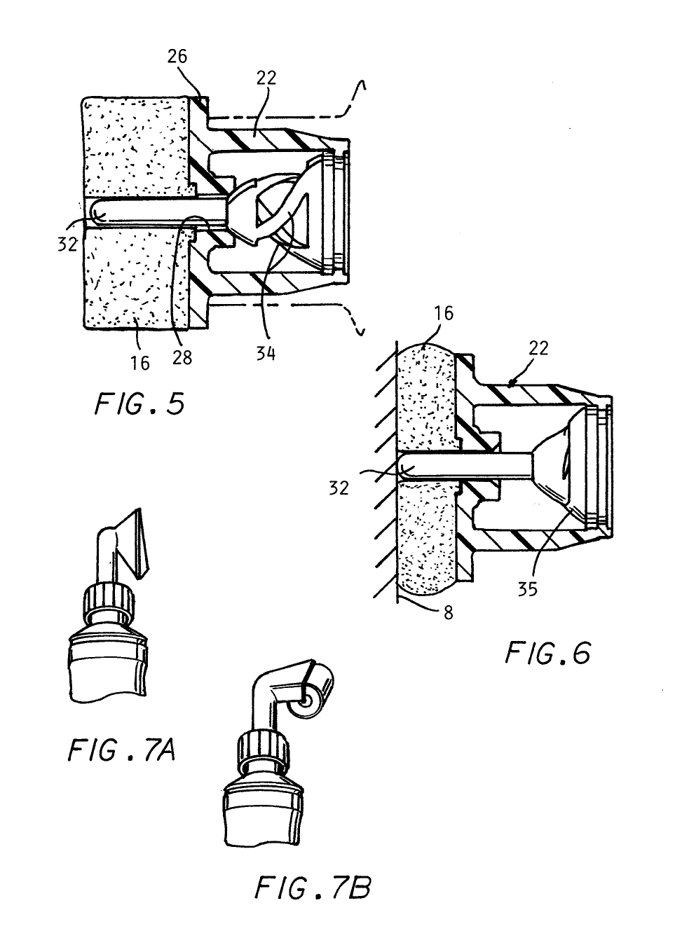

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

The method of the present invention preferably uses a storage applicator device 10 which is of a type previously known and used but for other purposes, which features a container 14 used to permanently store a small volume of a paint matching the existing painted surface.

The cap 12 may have an indicator patch 20 thereon of the color of the touch up paint contained therein.

When a touch up of a painted surface 8 is desired, a sealing cap 12 is removed from the container 10 to expose a porous applicator pad. The paint in the container 14 is controllably dispensed into the porous applicator pad 16 by a dispenser plunger 30 being shifted from a closed to an open position by compression of the applicator pad 20.

This allows an outflow of a small volume of paint when the container 14 is squeezed by the hand of a user of a volume determined by the degree of squeezing applied to the container 14.

The dispenser plunger 30 is held within a hollow plug 22 which in turn is secured as by a snap or tapered fit within a neck 24 of the container 14. The upper end of the hollow plug 22 is substantially closed off by an integral disc 26. A small central opening 28 in the disc 26 receives the plunger 30 which has a rod portion 32 having a section interfit to the opening 28 to close off the opening 28 under the urging of resiliently deflectable elements 34 integral with and extending from the rod portion 32 extending spirally from a ring 35 press fit within the hollow plug portion 22.

The plunger rod portion 32 extends through the disc 24 and up into a hole 17 in the pad 16. The compressible porous applicator pad 16 is affixed to the outside of the disc 26 with the plunger rod 32 extending up within the hole 17 in the applicator pad 16.

The pad 16 is affixed to the outside of the disc 26 as by an adhesive, the pad receiving the outflow of paint forced from the container 14 by squeezing the same when the pad 16 is compressed sufficiently to move the plunger portion 32 so as to open the small opening 28 and allow outflow of paint into the porous pad 16.

The deflectable elements 34 are partially compressed when the plunger body 36 is snap or press fit into the hollow plug portion 22 to continuously urge the rod portion 32 into the opening 28 so as to close off and seal the opening 28 and prevent dispensing of any paint until the pad 16 is again compressed.

The pad 16 is cleaned after each use.

The cap 12 is then installed over the dispenser applicator to protect and completely seal off these components.

Thus, matching touch up paint is permanently stored in the container 14 and is instantly available to a user to neatly and conveniently dispense a small volume of paint into the pad 16, and to apply the same to the surface by rubbing the applicator pad 16 on the blemished area of the painted surface 8 to apply the paint held within the pad 16 onto the surface 8.

Alternate forms of applicators 40, 42 which could be used are shown in FIGS. 7A and 7B.

1. A method of maintaining a painted surface comprising storing a volume of touch up paint matching the paint on the painted surface in a compact sealed container able to be squeezed by the hand of a user, said container having a selectively operated dispenser installed in a neck of said container and a porous applicator pad mounted to said dispenser to receive paint forced from said container by squeezing thereof and dispensed into the pad by said dispenser; and
applying paint dispensed into said applicator pad to said painted surface by rubbing said pad thereon.

2. The method according to claim 1 further including selectively moving a rod portion of a dispenser plunger to open a small opening in a dispenser plug portion so as to allow an outflow of paint squeezed from said container into said applicator pad.

3. The method according to claim 2 including compressing said porous pad into which said dispenser rod portion extends to move said rod portion by compressing said pad so as to open said small opening and allow outflow of paint from said container to be forced into said pad.
